(19) United States
(12) Patent Application Publication
(10) Pub. No.: US 2015/0066232 A1
(43) Pub. Date: Mar. 5, 2015

(54) INFORMATION DISPLAY DEVICE, COMPUTER PROGRAM PRODUCT, AND DISPLAY SYSTEM

(71) Applicant: KABUSHIKI KAISHA TOSHIBA, TOKYO (JP)

(72) Inventors: Satoshi Odakura, Kodaira-shi (JP); Noriyuki Hirayama, Fuchu-shi (JP); Hiroko Ishikawa, Nakano-ku (JP); Mayuko Yoshida, Ota-ku (JP); Toshiaki Takama, Ageo-shi (JP)

(73) Assignee: KABUSHIKI KAISHA TOSHIBA, TOKYO (JP)

(21) Appl. No.: 14/174,333

(22) Filed: Feb. 6, 2014

(30) Foreign Application Priority Data
Aug. 27, 2013 (JP) 2013-176053

(51) Int. Cl. G05B 15/02; G06F 3/0484

(52) U.S. Cl. CPC G05B 15/02; G06F 3/0484
USPC 700/297

(57) ABSTRACT

According to at least one embodiment, an information display device includes a receiver and a display. The receiver is configured to receive, from one or more devices, information indicating power consumption of one or more spaces in which electronic devices can be installed and/or one or more electronic devices. The display controller is configured to display animations corresponding to the power consumption of the one or more spaces and/or one or more electronic devices, such that differences in the power consumption among the one or more spaces and/or one or more electronic devices are displayed as differences in animation speeds.

### CROSS-REFERENCE TO RELATED APPLICATIONS

This application is based upon and claims the benefit of priority from Japanese Patent Application No. 2013-176053, filed Aug. 27, 2013, the entire contents of which are incorporated herein by reference.

### FIELD

Embodiments described herein relate generally to an information display device, a computer program product, and a display system.

### BACKGROUND

Conventionally, there has been known a home energy management system (HEMS) as an energy management system of electronic devices and the like in power consumers including households and stores. For such HEMS, it has been necessary to read numerical values of power consumption from a graph and the like, thereby the power consumption could not be intuitively recognized.

In recent years, there has been proposed a technique of displaying life information such as a power generation amount and a usage power amount as animation. A user can observe the animation so as to recognize the life information.

In the conventional techniques, animation display targets are limited to an indoor total power generation amount and an indoor total usage power amount. With increased requirement for energy saving, requirement for checking power consumption individually, for example, based on an electronic device and a room tends to be increased.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a view illustrating an example of an energy management system according to an embodiment;

FIG. 2 is a block diagram illustrating one example of a hardware configuration of an information display device in the embodiment;

FIG. 3 is a block diagram illustrating a configuration of an information display application 300 that is executed on the information display device in the embodiment;

FIG. 4 is a view illustrating a display example of animations indicating power consumptions of respective home electric appliances and respective rooms by a display controller in the embodiment;

FIG. 5 is a view illustrating an example of rotating animation of a circular icon image that is displayed by the display controller in the embodiment;

FIG. 6 is a view illustrating a display example of animations indicating power consumptions of respective home electric appliances that are displayed by the display controller when press of a “home electric appliance monitor” button is received, in the embodiment;

FIG. 7 is a view illustrating an example of a device setting screen that is displayed by the display controller in the embodiment when press of a setting button is received, in the embodiment;

FIG. 8 is a flowchart illustrating processing until power consumption is displayed in the information display device and an energy measuring device in the embodiment; and

FIG. 9 is a flowchart illustrating processing until power consumption is displayed in the information display device and a plurality of home electric appliances in the embodiment.

### DETAILED DESCRIPTION

In general, according to one embodiment, an information display device comprises a receiver and a display controller. The receiver is configured to receive, from one or more devices, information indicating power consumption of one or more spaces in which electronic devices can be installed and/or one or more electronic devices. The display controller is configured to display animations corresponding to the power consumption of the one or more spaces and/or one or more electronic devices, such that differences in the power consumption among the one or more spaces and/or one or more electronic devices are displayed as differences in animation speeds.

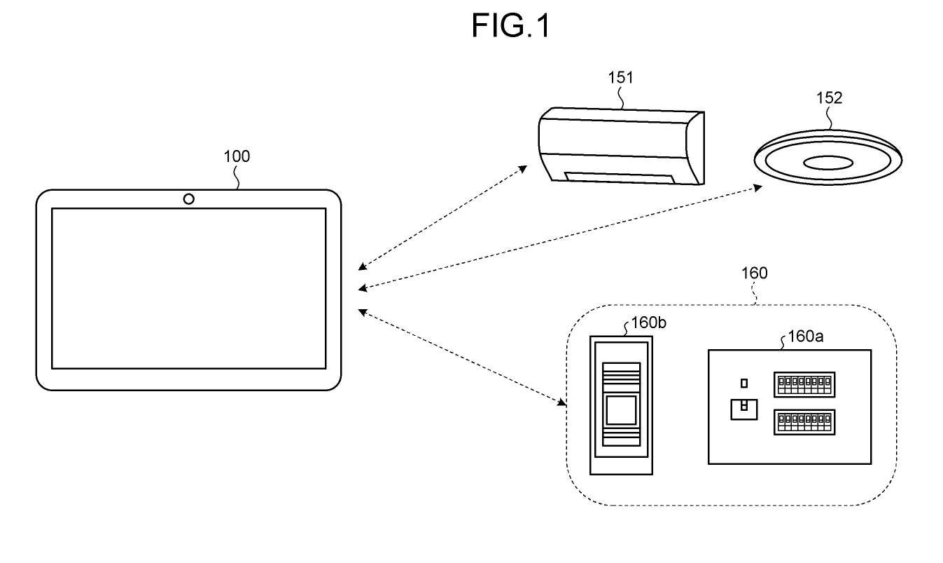

FIG. 1 is a view illustrating an example of an energy management system according to an embodiment. In the example as illustrated in FIG. 1, a user can grasp power consumption in a house by referring to an information display device 100 in the house. In the example as illustrated in FIG. 1, an air conditioner 151, an illumination device 152, and a combination 160 of a distribution board 160a and an energy measuring device 160b are installed in the house. In the embodiment, described is an example in which power consumption of each room in a house and power consumption of each home electric appliance and the like provided in each room are displayed. A measuring target of the power consumption is not limited to the house and it is sufficient that the measuring target of the power consumption is a space in which electronic devices can be installed, such as apartments and factories.

The embodiment describes an example of providing a tablet terminal as the information display device 100. The information display device 100 is not limited to the tablet terminal and it is sufficient that the information display device comprises an interface for communication, such as a personal computer (PC) and a smartphone.

Each of the information display device 100, the air conditioner 151, the illumination device 152, and the energy measuring device 160b in the embodiment comprises a wireless communication interface such as the Bluetooth (registered trademark) and the Wi-Fi (for example, IEEE802.11b/g/n and IEEE802.15.4) or a wired communication interface such as the Ethernet (registered trademark), and is capable of making communication. An ECHONET Lite communication protocol, as a communication protocol of an upper layer, is used for communication between the information display device 100 and the air conditioner 151, the illumination device 152, or the energy measuring device 160b.

The ECHONET Lite communication protocol is a protocol proposed for managing setting devices and the like in the household in an integrated manner in the household energy management system called a home energy management system (HEMS). The embodiment does not limit the protocol used for communication between the apparatuses to the ECHONET Lite communication protocol and other communication protocols may be used.

Branched breakers of the distribution board 160a are provided for respective rooms (spaces) partitioning an inner space of the house (building) and respective outlets to which the home electric appliances (household electronic devices) are connected. The energy measuring device 160b measures power consumption of each of the branched breakers with a sensor provided for the each of the branched breakers, and transmits the power consumption of the each of the branched breakers to the information display device 100.

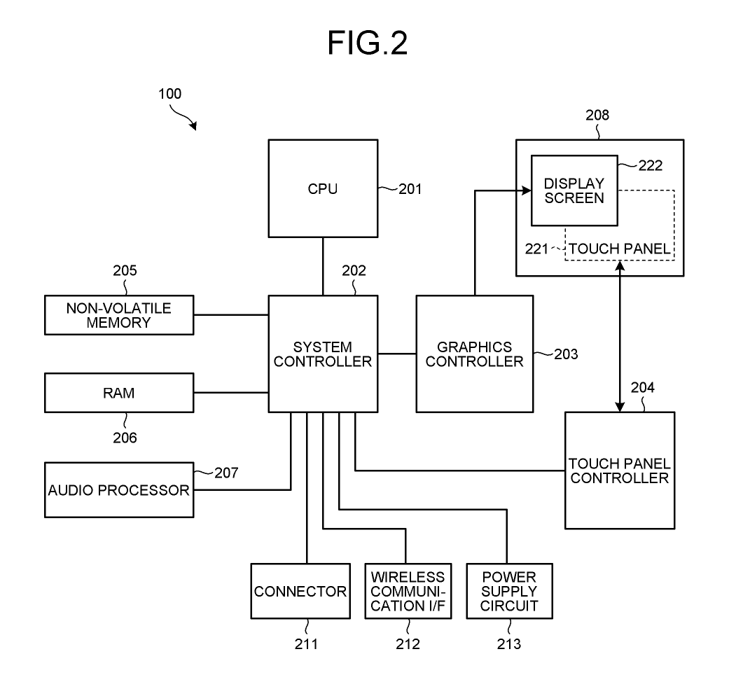

Described is a configuration of the information display device 100. FIG. 2 is a block diagram illustrating an example of a hardware configuration of the information display device 100 in the embodiment. As illustrated in FIG. 2, the information display device 100 in the embodiment comprises a central processing unit (CPU) 201, a system controller 202, a graphics controller 203, a touch panel controller 204, a non-volatile memory 205, a random access memory (RAM) 206, an audio processor 207, a display device 208, a connector 211, a wireless communication I/F 212, and a power supply circuit 213.

In the embodiment, the display device 208 comprises a touch panel 221 and a display screen (display) 222 such as a liquid crystal display (LCD) and an organic electro luminescence (EL). The touch panel 221 has a function of detecting position coordinates on its surface arranged on the display screen 222, for example. The touch panel 221 can detect a position (touch position) on a display region of the display screen 222 that has been touched by a finger of the user holding the information display device 100, for example. The display screen 222 functions as a what-is-called touch screen with an action of the touch panel 221.

The system controller 202 incorporates a memory controller that controls access to the non-volatile memory 205 and the RAM 206. The system controller 202 also has a function of executing communication with the graphics controller 203. Furthermore, the system controller 202 also incorporates a microcomputer integrated with an embedded controller. The embedded controller controls the power supply circuit 213 for supplying electric poser accumulated in a battery (not illustrated) comprised by the information display device 100.

The graphics controller 203 is a display controller for controlling display of an image on the display screen 222 that is used as a display monitor of the information display device 100. The touch panel controller 204 controls the touch panel 221, acquires a touch position on the display screen 222 that has been touched by the user from the touch panel 221, converts the touch position to position coordinate data, and outputs the position coordinate data to the CPU 201 through the system controller 202.

The audio processor 207 performs audio processing such as digital conversion, noise removal, and echo cancel on an audio signal that is input from a microphone (not illustrated) and outputs it to the CPU 201. Furthermore, the audio processor 207 outputs an audio signal generated by performing audio processing such as audio synthesis to a speaker (not illustrated) and outputs audio with the speaker under control by the CPU 201.

The connector 211 is a connection interface capable of connecting with a wired network such as the Ethernet (registered trademark). The information display device 100 in the embodiment may be connected to the home electric appliances 151 and 152, the energy measuring device 160b, and the like through the wired network.

The wireless communication I/F 212 serves as a wireless communication interface for connecting with the home electric appliances 151 and 152, the energy measuring device 160b, and the like by using the Bluetooth (registered trademark), the Wi-Fi, or the like.

The CPU 201 is a processor that centrally controls operations of the information display device 100 and controls the respective portions of the information display device 100 through the system controller 202. The CPU 201 executes an operating system that is loaded on the RAM 206 from the non-volatile memory 205. The RAM 206 provides, as a main memory of the information display device 100, an operation region when the CPU 201 executes the operating system or computer programs.

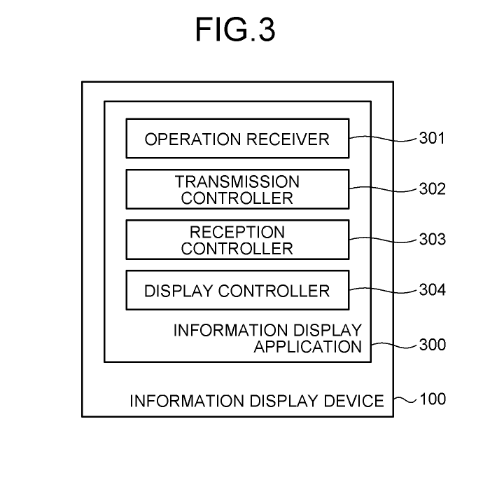

The CPU 201 executes an information display application on the operating system. FIG. 3 is a block diagram illustrating a configuration of an information display application 300 that is executed on the information display device 100 in the embodiment. As illustrated in FIG. 3, the information display application 300 comprises an operation receiver 301, a transmission controller 302, a reception controller 303, and a display controller 304.

The transmission controller 302 transmits data to the home electric appliances 151 and 152 and the energy measuring device 160b through the wireless communication I/F 212 or the like. For example, the transmission controller 302 transmits a power consumption acquisition request.

IP addresses indicating transmission destinations of the power consumption acquisition request and types (model names) indicating the home electric appliances or the distribution board as the transmission destinations thereof are registered previously in the information display device 100 in the embodiment.

In the embodiment, a direction defined as the ECHONET Lite communication protocol is used for the power consumption acquisition request. The transmission controller 302 in the embodiment transmits an acquisition request of property (for example, ECHONET object) of the home electric appliance 151 or 152 or the energy measuring device 160b that holds power consumption.

The reception controller 303 receives data from the home electric appliances 151 and 152 and the energy measuring device 160b through the wireless communication I/F 212 or the like. For example, the reception controller 303 transmits a power consumption acquisition response corresponding to the power consumption acquisition request transmitted from the transmission controller 302 from the home electric appliance 151 or 152 or the energy measuring device 160b. The power consumption acquisition response contains information indicating power consumption of each home electric appliance or each room.

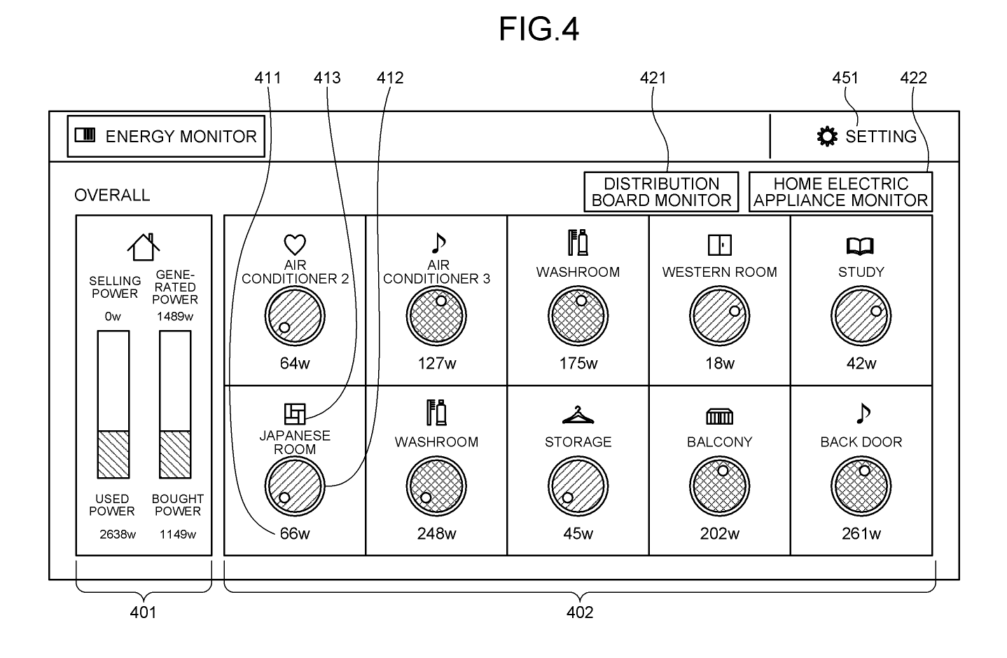

The display controller 304 displays various pieces of information on the display device 208. For example, the display controller 304 displays animations indicating power consumptions of respective home electric appliances or respective rooms. FIG. 4 is a view illustrating a display example of the animations indicating the power consumptions of the respective home electric appliances and the respective rooms by the display controller 304. In the screen example as illustrated in FIG. 4, a “distribution board monitor” button 421, a “home electric appliance monitor” button 422, and a setting button 451 are arranged. Furthermore, a display field 401 and a display field 402 are illustrated. Power consumption and generated power in the house overall are displayed on the display field 401. The power consumptions of the respective rooms and the respective home electric appliances that are managed based on the respective branched breakers of the distribution board are displayed on the display field 402.

The power consumptions of the respective branched breakers of the distribution board 160a installed in the house that have been measured by the energy measuring device 160b are displayed on the display field 402. To be more specific, the power consumptions of the respective home electric appliances “air conditioner 2” and “air conditioner 3” to which the branched breakers of the distribution board 160a are assigned are displayed on the display field 402. Furthermore, the power consumptions of the respective rooms “washroom”, “western room”, “study”, “Japanese room”, “washroom”, “storage”, “balcony”, and “back door” to which the branched breakers of the distribution board 160a are assigned are displayed on the display field 402.

Names assigned for the respective branched breakers of the distribution board 160a, animation displays, and power consumption numerical values are displayed on the display field 402. For example, a name “Japanese room” 413, an animation display 412, and a power consumption numerical value 411 are displayed on a field of the Japanese room, for example.

The display controller 304 displays differences in the power consumption among the respective rooms and the respective home electric appliances as differences in the animation speed. The display controller 304 in the embodiment displays a circular icon image indicating the power consumption as rotating animation. The rotating speed is made lower when an absolute value of the power consumption is smaller. As the numerical value of the power consumption is larger, the rotating speed is made higher in stages. When the power consumption is 0 w or an extremely small value, the display controller 304 displays the circular icon image in a non-rotational manner.

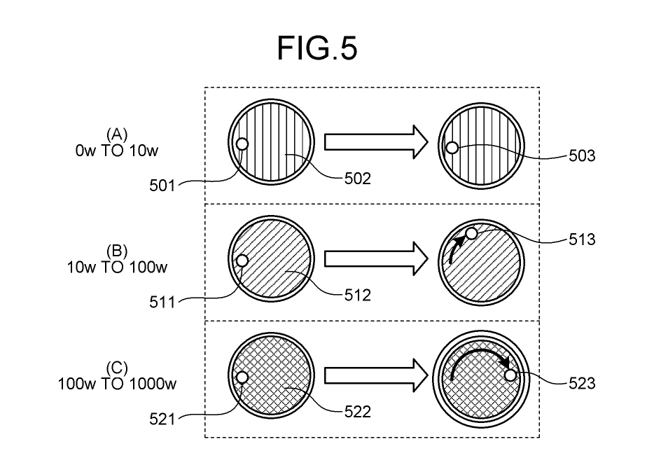

FIG. 5 is a view illustrating rotating animation of the circular icon image that is displayed by the display controller 304. As illustrated in FIG. 5, in the embodiment, as the absolute value of the power consumption is larger, the rotating speed is made higher in stages. Alternatively, as the absolute value of the power consumption is larger, the rotating speed may be made higher linearly or exponentially.

(A) of FIG. 5 illustrates the circular icon image that is displayed when the power consumption is 0 w to 10 w. In the example as illustrated in (A), the circular icon is present at an initial position 501, and the circular icon is present at a position 503 even when a predetermine period of time has elapsed. In this manner, when the power consumption is 0 w to 10 w, the display controller 304 does not rotate the circular icon and does not perform animation display.

(B) of FIG. 5 is a view illustrating the circular icon image that is displayed when the power consumption is 10 w to 100 w. In the example as illustrated in (B), the circular icon is present at an initial position 511, and the circular icon moves to a position 513 when a predetermine period of time has elapsed. In this manner, when the power consumption is 10 w to 100 w, the rotating animation of the circular icon is displayed.

(C) of FIG. 5 is a view illustrating the circular icon image that is displayed when the power consumption is 100 w to 1000 w. In the example as illustrated in (C), the circular icon is present at an initial position 521, and the circular icon moves to a position 523 when a predetermine period of time has elapsed. In the example as illustrated in (C), a movement distance is larger than that in (B). That is to say, when the power consumption is 100 w to 1000 w, it can be checked that the rotating speed on the animation of the circular icon is higher.

Furthermore, a display region 502 of the animation of (A) of FIG. 5, a display region 512 of the animation of (B) of FIG. 5, and a display region 522 of the animation of (C) of FIG. 5 are displayed in different colors. Thus, the display controller 304 in the embodiment makes colors of the animation display different in accordance with the difference in power consumption.

The initial position 501 of the circular icon in (A) of FIG. 5, the initial position 511 of the circular icon in (B) of FIG. 5, and the initial position 521 of the circular icon in (C) of FIG. 5 are the same. When the display controller 304 in the embodiment displays the animations indicating the power consumptions of the respective rooms and the respective home electric appliances, the initial positions of the circular icons that are displayed initially are made identical. When the initial positions are made identical, the user can grasp the difference in the power consumption easily when the user starts viewing the animations.

The operation receiver 301 receives an operation through the touch panel 221. For example, in the screen example as illustrated in FIG. 4, the operation receiver 301 receives press of the “home electric appliance monitor” button 422 as a display operation of the home electric appliance monitor. Furthermore, the operation receiver 301 receives press of the setting button 451 as a display operation of a setting screen.

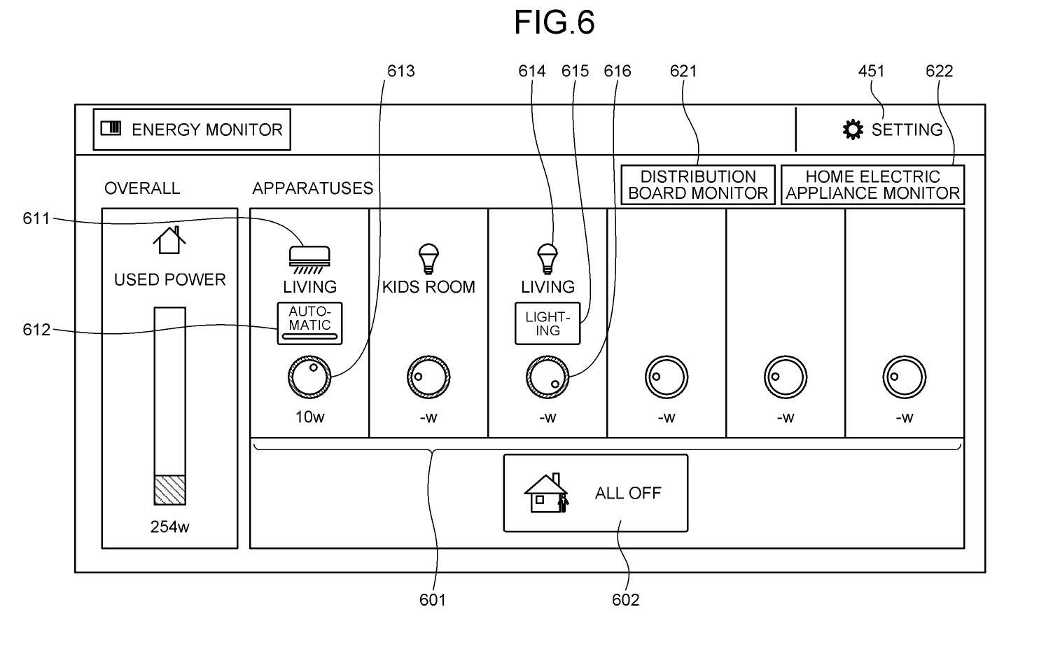

FIG. 6 is a view illustrating a display example of animations indicating the power consumptions of the respective electric appliances that are displayed when the operation receiver 301 receives press of the “home electric appliance monitor” button 422. In the screen example as illustrated in FIG. 6, a “distribution board monitor” button 621, a “home electric appliance monitor” button 622, and the setting button 451 are arranged. In the screen example as illustrated in FIG. 6, the power consumptions of the respective home electric appliances with which the information display device 100 makes communication are displayed on a display field 601.

To be more specific, the power consumptions of the respective home electric appliances with which the information display device 100 makes wireless communication through the Bluetooth (registered trademark), the Wi-Fi (for example, IEEE802.11b/g/n and IEEE802.15.4), or the like are displayed on the display field 601. In the example as illustrated in FIG. 6, an icon indicating the home electric appliance, a room in which the home electric appliance is provided, an operation state of the home electric appliance, animation display indicating the power consumption of the home electric appliance, and a power consumption numerical value are displayed for each home electric appliance.

For example, an icon 611 indicating an air conditioner, “living”, an operation state “automatic” 612, an animation display 613 of a circular icon indicating the power consumption of the air conditioner, and a power consumption numerical value “10 w” are displayed for one display item. The circular icon is rotated in the same manner as FIG. 5. Note that a reference of the power consumption based on which the rotating speed of the circular icon is switched is made different from that as illustrated in FIG. 5.

As another example, an icon 614 indicating an illumination, “living”, an operation state “lighting” 615, and an animation display 616 indicating the power consumption of the air conditioner are displayed for one display item. When the home electric appliance is the illumination, the power consumption is not displayed. The reason is because the power consumption of the illumination does not change depending on the situations and the power consumption amount is smaller than those of other home electric appliances. That is, it is sufficient that if it can be checked whether the illumination consumes power.

Thus, when the display controller 304 displays the animations indicating the power consumptions and the power consumption values for the respective home electric appliances, the display controller 304 controls to display only the animation and not to display the power consumption value for a predetermined home electric appliance.

Furthermore, the home electric appliances may be made to be capable of being controlled from the display screen as illustrated in FIG. 6. For example, when the operation receiver 301 receives press down of the operation state 612 of the air conditioner or press down of the operation state 615 of the illumination, the information display device 100 controls to switch the operation state of each home electric appliance. When the operation receiver 301 receives press down of an “all OFF” button 602, the information display device 100 controls to turn OFF the operations of all the home electric appliances displayed on the display field 601.

Power consumption as a reference of the rotating speed differs between the animation display on the display field 402 as illustrated in FIG. 4 and the animation display on the display field 601 on the display screen as illustrated in FIG. 6. For example, when the power consumption is equal to or higher than 10 w, the rotating animation of the circular icon is started on the display field 402 as illustrated in FIG. 4. When the power consumption is higher than 0 w, the rotating animation of the circular icon is started on the display field 601 as illustrated in FIG. 6. In this manner, the reference of the rotating speed of the circular icon is made different depending on measurement targets of the power consumption.

Moreover, on the animation display as illustrated in FIG. 6, colors and shapes of the icon images may be also changed in accordance with the power consumption.

Furthermore, the rotating animation of the circular icon image may be rotated in accordance with a relative difference between the standard power consumption of each home electric appliance and the actual power consumption thereof. When the actual power consumption of each home electric appliance is smaller than the standard power consumption thereof, the rotating speed is made lower. On the other hand, when the actual power consumption of each home electric appliance is larger than that, the rotating speed is made higher. Based on this, the user can grasp the degree of the power consumption consumed by the home electric appliance that is being used in comparison with the standard power consumption or the degree of the power saving visually.

In order that the information display device 100 displays the display screen as illustrated in FIG. 4 or FIG. 6, the user needs to set information relating to the home electric appliances and the rooms. In the embodiment, when the user presses the setting button 451 on the display screen as illustrated in FIG. 4 or FIG. 6, a setting screen is displayed.

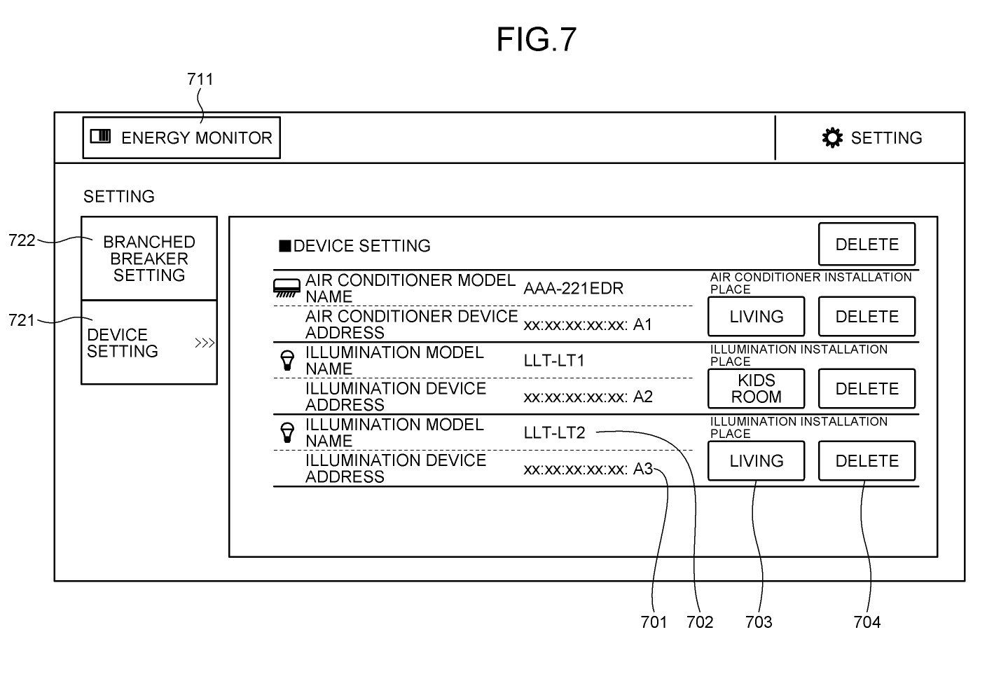

FIG. 7 is a view illustrating an example of a device setting screen that is displayed when the operation receiver 301 receives press down of the setting button 451 on the display screen as illustrated in FIG. 6. In the screen example as illustrated in FIG. 6, the user performs setting manually for each home electric appliance searched with a search button. In the embodiment, description relating to the search is omitted while the ECHONET Lite communication protocol is used for searching the home electric appliances.

As a result of the search, the display controller 304 displays a type (for example, icon) of the searched home electric appliance, the model name (for example, “LLT-LT2” 702) of the home electric appliance, and a device address (for example, “xx:xx:xx:xx:xx:A3” 701) of the home electric appliance in a correspondence manner. Then, the operation receiver 301 receives input of an installation place 703 of the searched home electric appliance from the user. Furthermore, it is sufficient that the user presses a delete button 704 when the user wants so as not to display the home electric appliance.

In the example as illustrated in FIG. 7, there is described the case where an “device setting” item 721 for setting the home electric appliances with which the information display device 100 can communicate is selected. When a “branched breaker setting” item 722 is selected, the operation receiver 301 receives setting of the room or the home electric appliance for each branched breaker of the distribution board 160a.

When the operation receiver 301 receives press down of an energy monitor button 711, the display controller 304 displays the display screen as illustrated in FIG. 6.

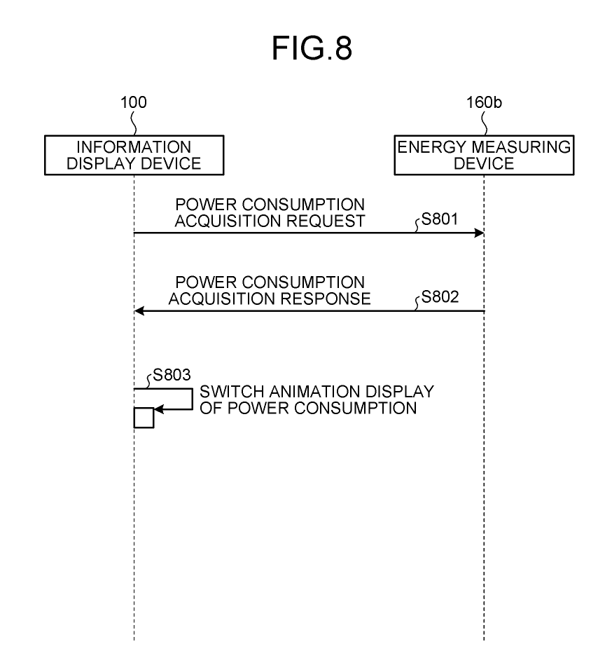

Next, it is described processing until the power consumption is displayed in the information display device 100 and the energy measuring device 160b in the embodiment. FIG. 8 is a flowchart illustrating the above-mentioned processing in the information display device 100 and the energy measuring device 160b in the embodiment.

First, the transmission controller 302 of the information display device 100 transmits a power consumption acquisition request to the energy measuring device 160b (S801).

When the energy measuring device 160b receives the power consumption acquisition request from the information display device 100, the energy measuring device 160b transmits, as a power consumption acquisition response, a measurement value of the power consumption of each branched breaker of the distribution board 160a to the information display device 100 (S802).

Then, when the information display device 100 receives the power consumption acquisition response from the energy measuring device 160b, the information display device 100 switches the animation display so as to display rotating animation based on the acquired power consumption (S803).

The information display device 100 in the embodiment requests to acquire the power consumption periodically, thereby enabling animation display of the power consumption based on the branched breaker of the distribution board 160a in real time. It is sufficient that an appropriate interval of the acquisition request is set in accordance with an execution mode and the interval is considered to be 30 seconds, for example.

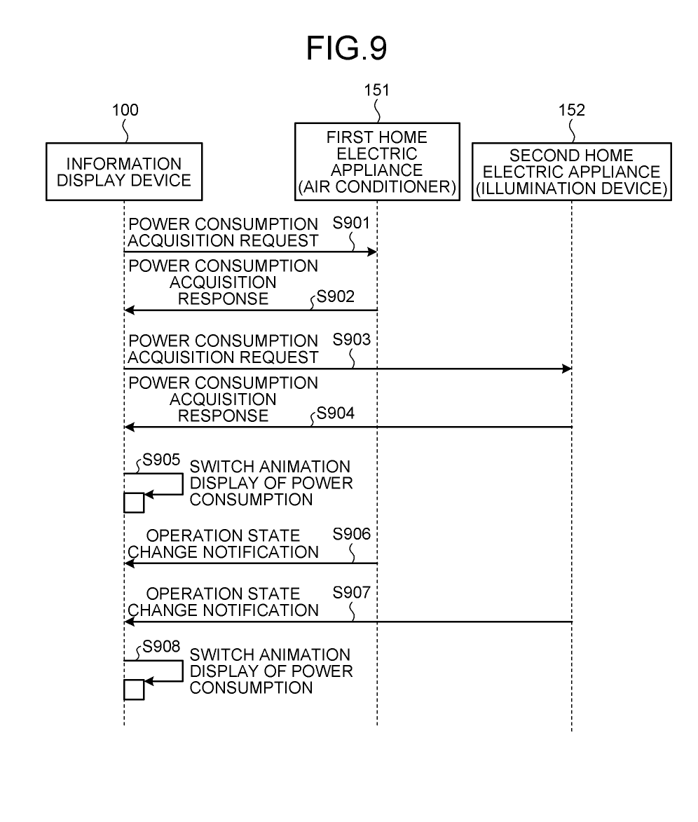

Next, it is described processing until the power consumption is displayed in the information display device 100 and the home electric appliances 151 and 152 in the embodiment. FIG. 9 is a flowchart illustrating the above-mentioned processing in the information display device 100 and the home electric appliances 151 and 152 in the embodiment.

First, the transmission controller 302 of the information display device 100 transmits a power consumption acquisition request to the first home electric appliance (for example, air conditioner) 151 (S901).

When the first home electric appliance (for example, air conditioner) 151 receives the power consumption acquisition request from the information display device 100, the first home electric appliance 151 transmits, as a power consumption acquisition response, a power consumption value that is being used to the information display device 100 (S902).

In the same manner, the transmission controller 302 of the information display device 100 transmits a power consumption acquisition request to the second home electric appliance (for example, illumination device) 152 (S903).

When the second home electric appliance (for example, illumination device) 152 receives the power consumption acquisition request from the information display device 100, the second home electric appliance 152 transmits, as a power consumption acquisition response, a power consumption value that is being used to the information display device 100 (S904).

Then, the information display device 100 receives the power consumption acquisition responses from the first home electric appliance (for example, air conditioner) 151 and the second home electric appliance (for example, illumination device), the information display device 100 switches animation display so as to display rotating animations based on the acquired power consumptions (S905).

Furthermore, the information display device 100 receives an operation state change notification from the first home electric appliance (for example, air conditioner) 151 (S906). Moreover, the information display device 100 receives an operation state change notification from the second home electric appliance (for example, illumination device) 152 (S907).

In this manner, in the embodiment, the information display device 100 requests to acquire power consumption periodically so as to update the animation display. When the operation state of the first home electric appliance (for example, air conditioner) 151 or the second home electric appliance (for example, illumination device) 152 is changed, the information display device 100 is notified of the change. The operation state change notification contains information (for example, power supply OFF) indicating the state after changed and information indicating power consumption.

Then, when the information display device 100 receives the operation state change notification from the first home electric appliance (for example, air conditioner) 151 or the second home electric appliance (for example, illumination device) 152, the information display device 100 switches the animation display so as to display the rotating animation based on the acquired power consumption (S908).

The information display device 100 can display the animations of the power consumptions of the first home electric appliance (for example, air conditioner) 151 and the second home electric appliance (for example, illumination device) 152 with the above-mentioned processing procedures. Furthermore, the information display device 100 can display the operation state after changed immediately and animation of power consumption in accordance with the operation state after changed after the operation state of the first home electric appliance (for example, air conditioner) 151 or the second home electric appliance (for example, illumination device) 152 is changed.

Although the embodiment has described the case where the acquisition targets of the power consumption are the energy measuring device 160b provided on the distribution board 160a and the home electric appliances 151 and 152 capable of making communication, the acquisition target is not limited thereto as long as the power consumption can be acquired therefrom.

The information display device 100 in the above-mentioned embodiment uses image data of which animation is rotated as display of power consumption of each electronic device or each room. In this case, the rotating speed of the rotating animation is switched in stages in accordance with the power consumption so as to express the magnitude of the power consumption. For example, when the power consumption is large, the rotating speed is made higher, whereas when the power consumption is small, the rotating speed is made lower. This enables the user to grasp the power consumption intuitively.

Although the information display device 100 in the embodiment changes the rotating speed of the rotating animation based on the absolute value of the power consumption, the rotating speed of the rotating animation is not limited to be changed based on the absolute value of the power consumption. For example, the display controller 304 of the information display device 100 may change the rotating speed of the rotating animation in accordance with a relative difference between the standard power consumption and the actual power consumption of the electronic device or the room.

The information display device 100 in the embodiment changes the rotating speed of the rotating animation in accordance with the power consumption of the room or the electronic device. This enables the user to check the power consumption easily.

The information display application 300 to be executed in the information display device 100 in the embodiment is provided by being recorded in a recording medium that can be read by a computer, such as a compact disc read only memory (CD-ROM), a flexible disk (FD), a CD recordable (CD-R), or a digital versatile disk (DVD), in an installable or executable file format.

The information display application 300 to be executed in the information display device 100 in the embodiment may be configured to be provided by being stored on a computer connected to a network such as the Internet and being downloaded through the network. Alternatively, the information display application 300 to be executed in the information display device 100 in the embodiment may be configured to be provided or distributed through a network such as the Internet.

The information display application 300 in the embodiment information may be configured to be provided by being incorporated in a read-only memory (ROM) or the like previously.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information display device comprising:
a receiver configured to receive, from one or more devices, information indicating power consumption of one or more spaces in which electronic devices can be installed and/or one or more electronic devices; and
a display controller configured to display animations corresponding to the power consumption of the one or more spaces and/or one or more electronic devices, such that differences in the power consumption among the one or more spaces and/or one or more electronic devices are displayed as differences in animation speeds.

2. The information display device of claim 1, wherein the display controller is configured to display the differences in the power consumption as differences in rotating speeds.

3. The information display device of claim 1, wherein the receiver is configured to receive, from the one or more devices, information indicating power consumption of one or more branched breakers of a distribution board, the one or more branched breakers corresponding to one or more partitioned spaces of an inner space of a building and/or one or more outlets each connected to an electronic device.

4. The information display device of claim 1, wherein the receiver is configured to receive the information through a communication network.

5. The information display device of claim 1, wherein the receiver is configured to receive the information from a measuring instrument through a communication network, and the one or more animations correspond to the power consumption of one or more branched breakers corresponding to one or more partitioned spaces of an inner space of a building and/or one or more outlets each connected to an electronic device.

6. The information display device of claim 5, wherein the one or more branched breakers correspond to the one or more partitioned spaces of the inner space of the building, and wherein power consumption as a reference of an animation speed differs between animation(s) indicating the power consumption of the one or more electronic devices and the animation(s) indicating the power consumption of one or more branched breakers.

7. The information display device of claim 1, wherein the display controller is configured to display the one or more animations together with a numerical value corresponding to the respective power consumption, and to only display animation and not to display a numerical value for at least one of the one or more electronic devices.

8. The information display device of claim 1, wherein the display controller is configured to make an initial position of the animation(s) constant.

9. The information display device of claim 1, wherein differences in the power consumption among the one or more spaces and/or one or more electronic devices are displayed as differences in color.

10. A computer program product having a non-transitory computer readable medium including programmed instructions, wherein the instructions, when executed by a computer, cause the computer to perform:
receiving, from one or more devices, information indicating power consumption of one or more spaces in which electronic devices can be installed and/or one or more electronic devices; and
displaying animations corresponding to the power consumption of the one or more spaces and/or one or more electronic devices, such that differences in the power consumption among the one or more spaces and/or one or more electronic devices are displayed as differences in an animation speed.

11. A display system comprising:
a measuring device configured to measure power consumption of one or more of a plurality of electronic devices or one or more of a plurality of spaces; and
an information display device configured to communicate with the electronic devices or the measuring device, wherein
the information display device comprises
a receiver configured to receive information indicating the power consumption of the one or more of the electronic devices or to receive information indicating the power consumption of the one or more of the spaces from the measuring device; and
a display controller configured to display animation indicating the power consumption of the one or more of the spaces or the one or more of the electronic devices, and to display a difference in the power consumption as a difference in an animation speed.

12. The display system of claim 11, wherein the display controller is configured to display the difference in the power consumption as a difference in a rotating speed of display information to be animated.
